(19) United States
(12) Patent Application Publication
(10) Pub. No.: US 2019/0073099 A1
(43) Pub. Date: Mar. 7, 2019

(54) METHOD AND DEVICE FOR LAUNCHING APPLICATION AND ELECTRONIC DEVICE

(71) Applicant: BEIJING KINGSOFT INTERNET SECURITY SOFTWARE CO., LTD., BEIJING (CN)

(72) Inventor: Delin LIU, BEIJING (CN)

(21) Appl. No.: 15/754,945

(22) PCT Filed: Sep. 5, 2016
(86) PCT No.: PCT/CN2016/098123

§ 371 Date: Feb. 23, 2018

(30) Foreign Application Priority Data
Sep. 28, 2015 (CN) 201510629761.8

(51) Int. Cl. G06F 3/0483; G06F 3/0484; G06F 3/0481; G06F 3/0488

(52) U.S. Cl. CPC G06F 3/0483; G06F 3/0488; G06F 3/04817; G06F 3/04847

(57) ABSTRACT

A method and a device for launching an application (APP) and an electronic device are provided. The method includes: acquiring a page sliding-up operation instruction from a user to display a preset sliding-up page having a first sequence number and having one or more application icons, in which the sliding-up page is a portion of a touch screen formed by dividing the touch screen and is within a range coverable by a single-sliding operation of a user; and determining an application icon corresponding to an application launching operation and launching an application corresponding to the application icon, according to the application launching operation from the user to the sliding-up page.

### CROSS-REFERENCE TO RELATED APPLICATIONS

This application is a U.S. national phase application of International Application No. PCT/CN2016/098123, filed Sep. 5, 2016, which claims priority to and benefits of Chinese Patent Application Serial No. 201510629761.8, filed with the State Intellectual Property Office of P. R. China on Sep. 28, 2015, the entire content of which is incorporated herein by reference.

### TECHNICAL FIELD

The present disclosure relates to the field of computer technology, and more particularly, to a method and a device for launching an application (APP) and an electronic device.

### BACKGROUND

With an increasing development of multi-media and communication technology, a touch screen, as a new input device, is widely applied to various mobile terminal device devices (such as mobile phones, personal digital assistants, mobile E-books and the like), because the touch screen has advantages of fast response, space saving, communication easily. In particular, as more and more applications are installed on the mobile terminal device, by arranging application icons for readily launching the applications on the touch screen in a certain application icon arrangement rule, the user only needs to touch the application icons via a finger or a touch pen, so as to launch the applications corresponding to the application icons, thereby making user operation easy, man-machine interaction direct and improving user experience.

With an increasing usage of the mobile terminal device in daily life and work for communicating, more and more requirements to usability and visual comfortability of the mobile terminal device are raised by the user. For example, in order to enhance the visual comfortability of the mobile terminal device during browsing through the mobile terminal device, a size of a touch screen of the mobile terminal device is bigger and bigger to facilitate the browsing through the mobile terminal device.

In a case that the size of the touch screen of the mobile terminal device is bigger and bigger, for most users, for example, for most office workers, leisure time period of the users focuses on the way to and from work (that is, in the bus or subway on their way to firm or to home). Only within this time period, could the users perform daily communications with others via the mobile terminal device. However, as this time period of the user is relatively fixed, during this period, the user needs to fix himself using one hand because the bus or the subway is crowded. Therefore, the user needs to hold the mobile terminal device with four fingers of another hand and to touch the touch screen using the thumb of another hand. As the size of the touch screen of the mobile terminal device is too big and the application icons are distributed evenly in the whole touch screen, the thumb cannot touch the whole touch screen. That is to say, with a single-hand mode, it is difficult to touch validly all application icons included in the touch screen. As a result, with touches of the thumb, some application icons cannot be selected and thus the applications corresponding to the application icons cannot be launched. Even though the thumb slides the touch screen for more times, it is difficult to touch these application icons, which increases the number of man-machine interactions, increases a calculation amount of the mobile terminal device, and wastes large calculation resources of the mobile terminal device. Furthermore, a selection of the application icon and a launch of the application are inconvenient, a process procedure is complexed, and duration is long and efficiency of launching the application is low.

### SUMMARY

Embodiments of the present disclosure provide a method for launching an application. The method includes:

acquiring a page sliding-up operation instruction from a user to display a preset sliding-up page having a first sequence number and having one or more application icons, in which the sliding-up page is a portion of a touch screen formed by dividing the touch screen and is within a range coverable by a single-sliding operation of a user; and

determining an application icon corresponding to an application launching operation and launching an application corresponding to the application icon, according to the application launching operation from the user to the sliding-up page.

Embodiments of the present disclosure provide an electronic device. The electronic device includes a housing, a processor, a memory, a circuit board and a power supply circuit. The circuit board is enclosed by the housing; the processor and the memory are positioned on the circuit board; the power supply circuit is configured to provide power for respective circuits or components of the electronic device; the memory is configured to store executable program codes; and the processor is configured to run a program corresponding to the executable program codes by reading the executable program codes stored in the memory, to perform the method for launching an application described above.

Embodiments of the present disclosure provide a computer readable storage medium, with instructions stored. When the instructions are executed by a processor of a terminal, the terminal executes the method for launching an application described above.

Embodiments of the present disclosure provide a computer program. When the computer program is executed on a processor, the method for launching an application described above is executed.

### BRIEF DESCRIPTION OF THE DRAWINGS

In order to illustrate embodiments of the present disclosure or technical solutions in the related art more clearly, drawings used in embodiments or in the related art will be described simply below. It is obviously that, the drawings described below are merely some embodiments of the present disclosure. For those skilled in the art, other drawings may be obtained according to these drawings without any inventive labors.

FIG. 1 is a flow chart illustrating a method for launching an application according to embodiments of the present disclosure;

FIG. 2 is a schematic diagram illustrating a sliding-up page via a sliding-up operation according to embodiments of the present disclosure;

FIG. 3 is a schematic diagram of editing application icons included in a sliding-up page according to embodiments of the present disclosure;

FIG. 4 is a block diagram illustrating a device for launching an application icon according to embodiments of the present disclosure; and

FIG. 5 is a schematic diagram illustrating an electronic device according to embodiments of the present disclosure.

### DETAILED DESCRIPTION

Embodiments of the present disclosure will be described with reference of drawings.

It should be clear that, embodiments illustrated herein are merely some embodiments instead of all embodiments of the present disclosure. On the basis of the embodiments of the present disclosure, for those skilled in the art, all other embodiments obtained without inventive labors fall in the scope of the present disclosure.

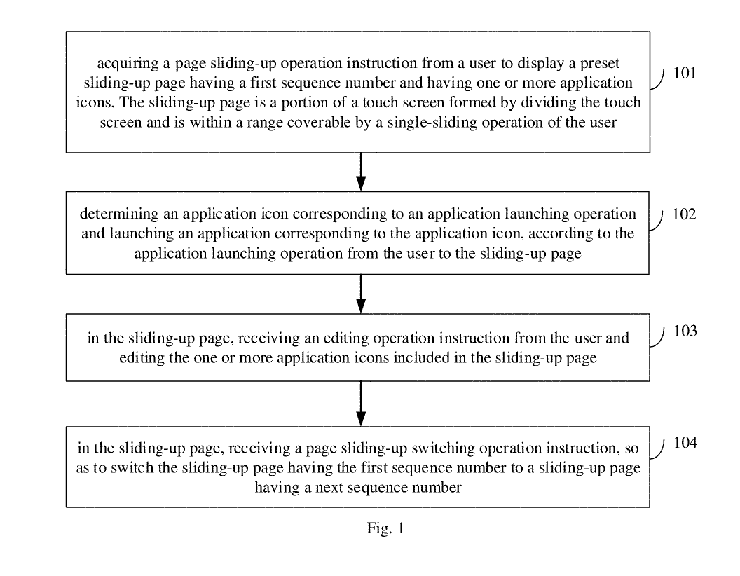

FIG. 1 is a flow chart illustrating a method for launching an application according to embodiments of the present disclosure. As illustrated in FIG. 1, the method includes the followings.

At block 101, a page sliding-up operation instruction is acquired from a user to display a preset sliding-up page having a first sequence number and having one or more application icons. The sliding-up page is a portion of a touch screen formed by dividing the touch screen and is within a range coverable by a single-sliding operation of the user.

In this block, it is assumed that the user locates in a crowded bus or subway. If the user desires to operate a mobile terminal device, it is impossible to touch all application icons displayed on the touch screen through the thumb when the size of the touch screen of the mobile terminal device is relatively large. In this case, by performing a preset page sliding-up operation, the page sliding-up operation instruction is output. Therefore, the method for launching the application according to the embodiments of the present disclosure is triggered so as to launch the application corresponding to the application icon touched by the user. If the operation performed is not the page sliding-up operation, it is processed according to a common operation on the touch screen of the mobile terminal device.

As an alternative embodiment, acquiring the page sliding-up operation instruction includes the followings.

A single-sliding operation input by the user to the touch screen is acquired. It is judged whether the single-sliding operation matches with a preset page sliding-up operation. If yes, the page sliding-up operating instruction is output; and if no, a process is performed according to a common single-sliding operation. The single-sliding operation input by the user to the touch screen may refer to one sliding operation input by the user to the touch screen.

In this block, as a thumb generally actives at four corner regions of the touch screen, the page sliding-up operation may be set as a sliding operation with a preset inclination angle within the four corner regions. For example, the page sliding-up operation may include: within a bottom-left corner region, a bottom-right corner region, a top-left corner region and a top-right corner region, a sliding operation from top-right to bottom-left, or a sliding operation from bottom-left to top-right. The inclination angle from top-right to bottom-left or the inclination angle from bottom-left to top-right is within the preset inclination range. Certainly, in practice, the page sliding-up operation may also include a sliding operation from top-left to bottom-right or a sliding operation from bottom-right to top-left within the four corner regions, or a preset sliding operation in other regions rather than the four corner regions of the touch screen, or a non-sliding operation, which is not limited in embodiments of the present disclosure.

In embodiments of the present disclosure, taking the sliding operation from bottom-left to top-right within the bottom-left corner region as the preset page sliding-up operation to illustrate, judging whether the single-sliding operation input by the user matches with the preset page sliding-up operation includes followings.

At act A11, a beginning point and an ending point of the sliding operation of the user are acquired. It is judged whether both the beginning point and the ending point are within the bottom-left corner region. If yes, an act A12 is executed; and if no, it is determined that the single-sliding operation input by the user does not match with the preset page sliding-up operation.

At act A12, it is judged whether a direction from the beginning point to the ending point is from bottom-left to top-right. If yes, an act A13 is executed; and if no, it is determined that the single-sliding operation input by the user does not match with the preset page sliding-up operation.

At act A13, an intersection angle between a line having the direction from the beginning point to the ending point and a horizontal line of the touch screen is calculated. It is judged whether the intersection angle is within the preset inclination range. If yes, it is determined that the single-sliding operation input by the user matches with the preset page sliding-up operation; and if no, it is determined that the single-sliding operation input by the user does not match with the preset page sliding-up operation.

In embodiments of the present disclosure, as an alternative embodiment, the sliding-up page is a skew triangle shaped page. The application icons are arranged in a skew triangle form in the skew triangle shaped page. Certainly, in practice, the sliding-up page may be set to have other shapes, for example, the sliding-up page may be rectangle shaped, pentagon shaped or irregular shaped, as long as the sliding-up page is within a range coverable by the single-sliding operation via the thumb of the user. Since the range coverable by the thumb may cover the whole sliding-up page, the application icons included in the sliding-up page may be directly operated and touched by the user, thereby launching the application corresponding to the application icon touched without sliding the touch screen for many times via the thumb. As a result, it is of nonexistence that the user cannot touch the application icons, thereby reducing effectively the number of human-terminal interactions, reducing a calculation amount of the mobile terminal device and saving calculation resource of the mobile terminal device. Furthermore, it facilitates a convenient and quick launching of the application by the user and simplifies an operation procedure of selecting the application icon and of launching the application corresponding to the application icon. Therefore, duration of launching the application is shortened and efficiency of launching the application is improved.

In embodiments of the present disclosure, as the sliding-up page is the portion of the touch screen by dividing the touch screen, the number of the application icons displayable on the sliding-up page is less than that displayed on the touch screen (whole screen). Therefore, it requires to preset one or more sliding-up pages to accommodate the application icons corresponding to all the applications installed on the mobile terminal device.

In embodiments of the present disclosure, as an alternative embodiment, setting the sliding-up page includes the followings.

At act A21, all application icons on the touch screen are categorized according to a preset categorization strategy.

In this act, as an alternative embodiment, the categorization strategy may be one for categorizing the application icons into a frequently-used application category, a social application category, a financial application category, a game application category and the like.

It is to be illustrated that, one application icon may be categorized to different application categories. For example, the application icon, such as Wechat, may be categorized into the frequently-used application category and the social application category as well.

At act A22, one or more application icons of a respective category are arranged into one or more sliding-up pages according to an application icon arrangement rule of the sliding-up page.

In this act, if the sliding-up page is skew triangle shaped, the application icons are arranged in a skew triangle shape. If one sliding-up page cannot accommodate all application icons corresponding to one category, the remaining application icons may be arranged in a next sliding-up page.

At act A23, the one or more sliding-up pages corresponding to the respective category are set with one or more sequence numbers respectively.

In this act, the one or more sliding-up pages corresponding to the respective category may be set with the sequence numbers by the user according to actual demands. For example, the sequence number of the one or more sliding-up pages corresponding to the frequently-used application category may be set to be one, the sequence number of the one or more sliding-up pages corresponding to the social application category may be set to be two, the sequence number of the one or more sliding-up pages corresponding to the financial application category may be set to be three, and the sequence number of the one or more sliding-up pages corresponding to the game application category may be set to be four.

As another alternative embodiment, the method further may include followings.

A sliding-up page control of each category is set at bottom of each sliding-up page.

In this act, in a case that a plurality of sliding-up pages correspond to one category, if the user desires to switch one of the plurality of sliding-up pages to another sliding-up page corresponding to another category, it needs to switch the plurality of sliding-up pages one by one, thus increasing the user's operations. In order to reduce the user's operations, a sliding-up page control of each category may be set at bottom of each sliding-up page. For example, for each sliding-up page corresponding to the frequently-used application category, a page sliding-up control corresponding to the social application category, a page sliding-up control corresponding to the financial application category, and a page sliding-up control corresponding to the game application category are set at the bottom. The page sliding-up control is linked to the sliding-up page having the first sequence number corresponding to the category.

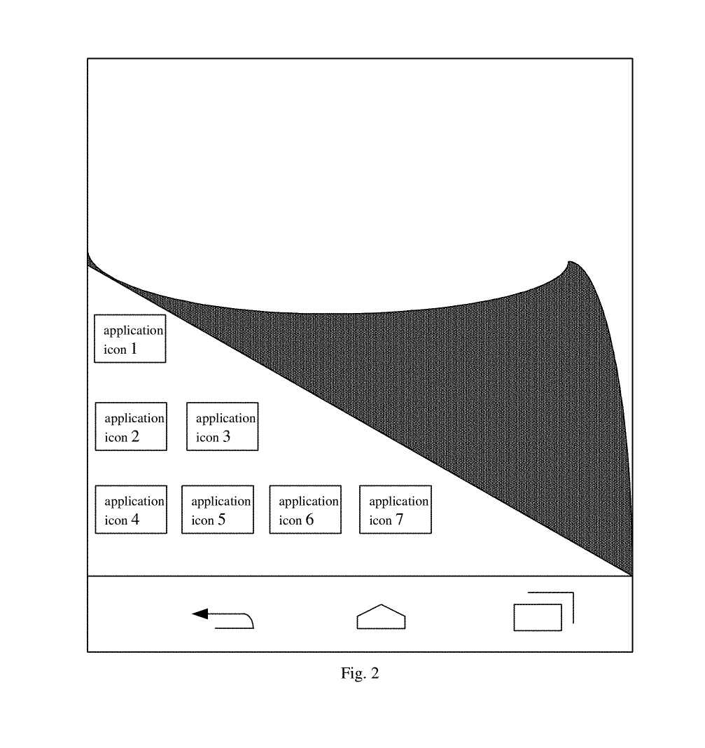

FIG. 2 is a schematic diagram illustrating a sliding-up page via a sliding-up operation according to embodiments of the present disclosure. As illustrated in FIG. 2, after the page sliding-up operation instruction input by the user is received, a skew triangle shaped page (i.e. the sliding-up page) is displayed at a bottom-left corner of the touch screen. The skew triangle shaped page may be covered by the range coverable by the single-sliding operation via the thumb of the user. The application icons are arranged according to the skew triangle shape in the skew triangle shaped sliding-up page. The residual portion of the touch screen above the skew triangle shaped sliding-up page is another portion of the touch screen by dividing the touch screen.

As an alternative embodiment, the method may further include followings.

One or more messages received by one or more applications are displayed on a page corresponding to another portion of the touch screen formed by dividing the touch screen.

In this act, in order to effective utilize the page corresponding to the another portion of the touch screen above the skew triangle shaped page, after the sliding-up page is displayed, in a case that no application is launched, the page corresponding to the another portion is set to display one or more offline messages received by the one or more applications installed in the mobile terminal device. For example, messages pushed by the social applications, such as QQ and Wechat, or preferential messages pushed by the financial applications may be displayed.

As an alternative embodiment, displaying one or more messages received by one or more applications may include followings.

The one or more messages received are displayed in sequence according to a chronological order of receiving the one or more messages; and if a capacity of messages displayed exceeds a capacity of the page corresponding to the another portion, the messages received are displayed in an abbreviated form.

In this act, displaying the messaged received in the abbreviated form may be displaying that there are X messages in total.

In embodiments of the present disclosure, the method may further include followings.

If the user touches the message displayed, an application corresponding to the touched message is launched in the touch screen, and after existing the launched application, the touch screen is restored as the sliding-up page and the page corresponding to the another portion and the touched message is deleted from the page corresponding to the another portion.

As another alternative embodiment, in order to reduce interference of displaying the one or more messages to the user, displaying one or more messages received by one or more applications may include followings.

Within a preset display time period, one or more offline messages received are buffered. When the preset display time period is over, there are two cases.

If the one or more offline messages correspond to one application, when the number of the one or more offline messages is less than a preset first number, the one or more offline messages are displayed according to a chronological order of receiving the one or more offline messages; or when the number of the one or more offline messages is not less than the preset first number, offline messages of the preset first number are displayed according to the chronological order of receiving the one or more offline messages and the number of the one or more offline messages is displayed behind the final offline message displayed.

If the one or more offline messages correspond to a plurality of applications, a message item for each application is set. The message item includes an application icon and the number of offline messages. When the number of the message items exceeds a preset second number, messages items of the preset second number are displayed according to a preset displaying strategy and the number of the message items is displayed behind the final message items displayed.

In this act, as an alternative embodiment, in order to enhance the user browse experience, when the messages are displayed, an animation effect may be set during displaying the messages. For example, a transparency of the messages displayed in the chronological order of receiving the messages is reduced gradually.

At block 102, an application icon corresponding to an application launching operation is determined and an application corresponding to the application icon is launched, according to the application launching operation input by the user to the sliding-up page.

In this block, as an alternative embodiment, the application may be launched by touching the application icon corresponding to the application. Certainly, in practice, the application may be launched by double-touching the application icon or other operations on the application icon.

As an alternative embodiment, the method may further include the followings.

At block 103, in the sliding-up page, an editing operation instruction from the user is received, and the one or more application icons included in the sliding-up page are edited.

In this block, as an alternative embodiment, receiving the editing operation instruction from the user includes the followings.

A long-time-press operation on any one of the application icons input by the user is received. It is judged whether a duration of the long-time-press operation exceeds a preset duration threshold, if yes, the editing operation instruction is output; and if no, the procedure is ended.

In this block, judging whether the duration of the long-time-press operation exceeds the preset duration threshold is to prevent a false operation. The preset duration threshold may be set as needed. For example, the preset duration threshold may be set as 1 second or 1.5 seconds or the like. Certainly, in practice, an editing operation control may be set in the sliding-up page. When the user touches the editing operation control, the editing operation instruction is output.

As an alternative embodiment, editing the one or more application icons included in the sliding-up page includes the followings.

At act B11, each application icon included in the sliding-up page is marked as a cancellable state.

At act B12, in a page corresponding to an another portion of the touch screen formed by dividing the touch screen, application icons corresponding to all applications installed on a mobile terminal device are displayed moveably and slidably. The number of the application icons may be too much such that the application icons are disable to be displayed completely in the page corresponding to the another portion of the touch screen, thereby displaying moveably and slidably the application icons. Sliding operations may be performed on pages of the another portion. Therefore, the pages of the another portion may be switched to display the application icons.

At act B13, it is deleted by touching the application icon in the cancellable state; and/or, an application icon included in the page corresponding to the another portion is selected and the application icon selected is added to an empty location of the sliding-up page.

At act B14, the one or more application icons included in the current sliding-up page are moved to sequence.

In this act, as an alternative embodiment, the application icons may be sequenced according to actual physical memory usage values (RSS) of the applications. Therefore, moving the application icons included in the current sliding-up page to sequence may include followings.

For each application corresponding to a respective application icon included in the sliding-up page, when the application is running, an actual physical memory usage value of the application is acquired, and in the sliding-up page, the application icons corresponding to the applications are sequenced in an increasing sequence or in a decreasing sequence according to the actual physical memory usage values.

As an alternative embodiment, moving the application icons included in the current sliding-up page to sequence may further include followings.

A usage number of each application corresponding to a respective application icon included in the sliding-up page is acquired, within a preset time period.

A running duration of each application within the preset time period is record.

For each application, a weighted sum of the usage number and the running duration is calculated.

In the sliding-up page, the application icons corresponding to the applications are sequenced according to the weighted sums.

In embodiments of the present disclosure, when the application icon is to be added in a case that there is no empty location in the sliding-up page, the user may be remaindered that there is no empty location in the sliding-up page and the user is questioned whether to delete another application icon included in the current sliding-up page.

As an alternative embodiment, editing the one or more application icons included in the current sliding-up page includes the followings.

At act B21, the application icons included in the current sliding-up page are marked as a cancellable state, and the touch screen having the sliding-up page and the page corresponding to the another portion is divided into a top region and a bottom region.

At act B22, the application icons marked in the cancellable state are arranged in the bottom region.

At act B23, in the top region, the application icons corresponding to all applications installed on the mobile terminal device are displayed moveably and slidably.

At act B24, it is deleted by touching the application icon in the cancellable state; and/or the application icon in the top region is selected and the selected application icon is added to the empty location of the bottom region.

At act B25, the application icons in the bottom region are arranged in the sliding-up page according to the application icon arrangement rule of the sliding-up page.

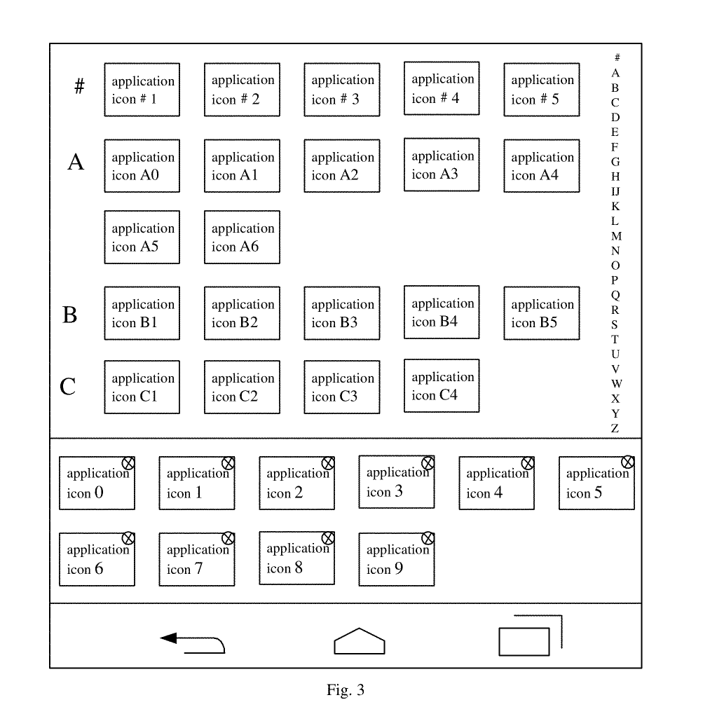

In embodiments of the present disclosure, as illustrated in FIG. 3, FIG. 3 is a schematic diagram of editing an application icon in the sliding-up page according to embodiments of the present disclosure. Taking a skew triangle shaped sliding-up page as an example, when an application icon is pressed for a long time (for example, more than 1 second), the application icons included in the skew triangle shaped sliding-up page may move so as to be arranged into two rows at the bottom of the touch screen. The application icons arranged into the two rows have a deleting sign respectively, such as a red “−” or a red “x”, which indicates that the application icons are in the cancellable state. The application corresponding to the application icon may be deleted by touching the deleting sign. Meanwhile, the application icons corresponding to all the applications installed on the mobile terminal device may be arranged according to an alphabetic order (such as from A, B, C to Z) or according to a number order and may be displayed in the top region of the touch screen. Pages of the top region of the touch screen may be slidable. The application icons included in the top region may be drug by the user to the empty location of the bottom region, thereby realizing to add the application icons. Alternatively, the application icon having the deleting sign (such as a red “−” or a red “x”) may be touched, which indicates that the application icon may be deleted from the skew triangle shaped region. The user may drag and change the application icons in the bottom region as needed so as to regulate the arrangement of the application icons. After the editing, a button in the bottom-right corner is touched to save, and the application icons in the bottom regions are automatically displayed in the sliding-up page according to the application icon arrangement rule of the sliding-up rule.

As another alternative embodiment, the method may further include the followings.

At block 104, in the sliding-up page, a page sliding-up switching operation instruction from the user is received, so as to switch the sliding-up page having the first sequence number to a sliding-up page of a next sequence number.

In this block, the page sliding-up switching operation instruction may be set as needed by the user. It should be illustrated that, in embodiments of the present disclosure, the page sliding-up operation, the application launching operation, the editing operation and the page sliding-up switching operation are different from each other.

In embodiments of the present disclosure, as an alternative embodiment, receiving the page sliding-up switching operation instruction, so as to switch the sliding-up page having the first sequence number to the sliding-up page of the next sequence number includes the followings.

At act C11, a horizontal sliding operation input by the user within a preset region in the sliding-up page is received to output the page sliding-up switching operation instruction.

In this act, it is judged whether the sliding operation input by the user to the sliding-up page is within the preset region. For example, the preset region is a middle region between a left region and a right region of the sliding-up page. Furthermore, it is judged whether an intersection angle between a direction of the sliding operation and a horizontal plane is within a preset first angle range (such as from −10 degree to 10 degree). Alternatively, the preset region is a bottom-left corner region of the sliding-up page. Furthermore, it is judged whether the intersection angle between the direction of the sliding operation and a horizontal plane is within a preset second angle range (such as from 40 degree to 45 degree). If the sliding operation is within the middle region or the bottom-left corner region, and the intersection angle is within the preset first angel range or the preset second angel range, it is determined that the sliding operation is the page sliding-up switching operation.

At act C12, the sliding-up page having the first sequence number is switched to the sliding-up page of the next sequence number.

In this act, if the current sliding-up page is not a last sliding-up page of the category, the current sliding-up page is switched to a next sliding-up page of the category. If the current sliding-up page is the last sliding-up page of the category, the current sliding-up page is switched to a first sliding-up page of another category of a next sequence number.

As another alternative embodiment, receiving the page sliding-up switching operation instruction so as to switch the sliding-up page having the first sequence number to the sliding-up page of the next sequence number includes the followings.

At act C21, a touch input by a user on a preset page switching control included in the sliding-up page is received to output the page sliding-up switching operation instruction.

In this act, the preset page switching control includes but not limited to: a last page control, a next page control, a first category page control (for example, a social application category page control), a second category page control (for example, a financial application category page control). As an alternative embodiment, the page switching control is positioned in a toolbar at the bottom of the sliding-up page.

At act C22, the sliding-up page having the first sequence number is switched to the sliding-up page of the next sequence number.

In this act, if the page switching control touched by the user is the last page control, the current sliding-up page is switched to an adjacent previous sliding-up page. If the page switching control touched by the user is the social application category page control, the current sliding-up page is switched to the sliding-up page having the first sequence number corresponding to the social application category. If the page switching control touched by the user is the financial application category page control, the current sliding-up page is switched to the sliding-up page with the first sequence number corresponding to the financial application category.

As described above, with the method for launching the application according to the embodiments of the present disclosure, by setting the sliding-up page covered by the range coverable by the single-sliding operation of the user, receiving the page sliding-up operation instruction from the user, and dividing the touch screen into two portions one of which includes the sliding-up page, the plurality of application icons arranged in the sliding-up page may be directly processed by the single-sliding operation of fingers of the user. Therefore, the application corresponding to the application icon touched is launched, so as to prevent sliding for many times via the thumb, to simplify the procedure of selecting the application icons and launching the corresponding application, to facilitate a convenient and quick launching of the application. Furthermore, the duration of launching the application is shortened and the efficiency of launching the application is improved. Moreover, by setting conveniently the frequently-used application icons, it is convenient for the user to change the application icons, and the user may intuitively perform the editing operation on the application icons included in the page. In other words, the user may delete, add and change the application icons readily via a drag operation of the fingers, and resulted effect is displayed in real time, which may satisfy various demands of the user to edit the application icons.

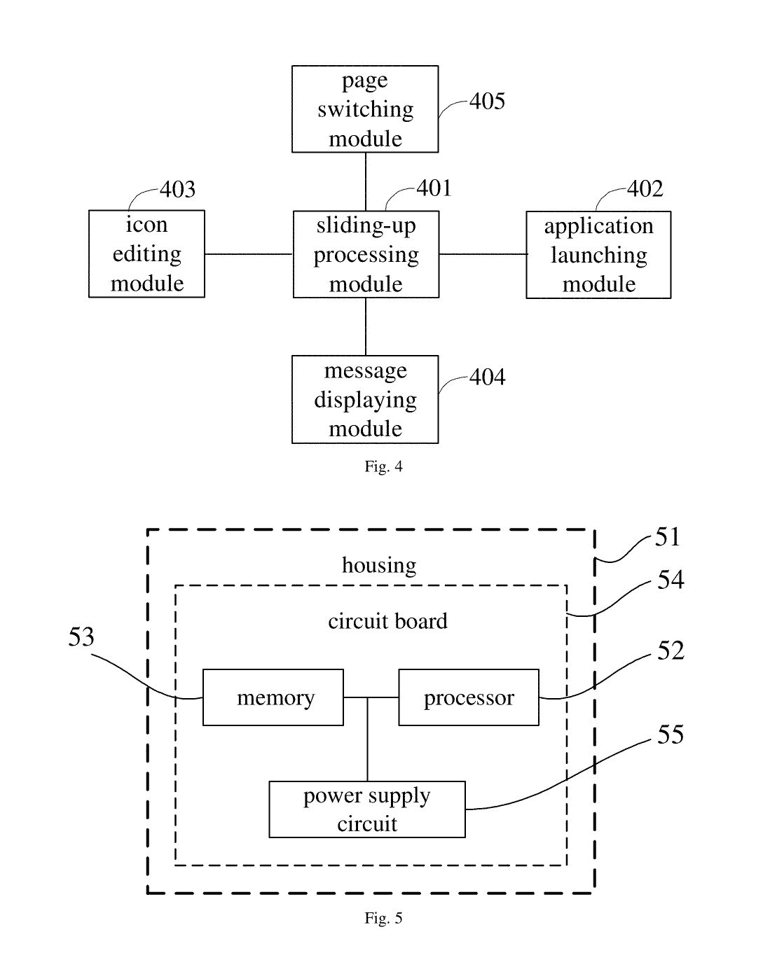

FIG. 4 is a block diagram illustrating a device for launching an application according to embodiments of the present disclosure. As illustrated in FIG. 4, the device includes a page sliding-up processing module 401 and an application launching module 402.

The page sliding-up processing module 401 is configured to acquire a page sliding-up operation instruction from a user to display a preset sliding-up page having a first sequence number and having one or more application icons. The sliding-up page is a portion of a touch screen formed by dividing the touch screen and is within a range coverable by a single-sliding operation of the user.

The application launching module 402 is configured to determine an application icon corresponding to an application launching operation, and to launch an application corresponding to the application icon, according to the application launching operation from the user to the sliding-up page.

In embodiments of the present disclosure, as an alternative embodiment, the device may further include an icon editing module 403.

The icon editing module 403 is configured to receive, in the sliding-up page, an editing operation instruction from the user and to edit the one or more application icons included in the sliding-up page.

In embodiments of the present disclosure, as an alternative embodiment, the page sliding-up processing module 401 includes: a page sliding-up setting unit, a sliding-up processing unit and a page sliding-up displaying unit (not shown).

The page sliding-up setting unit is configured to categorize all application icons on the touch screen according to a preset categorization strategy; to arrange one or more application icons of a respective category into one or more sliding-up pages according to an application icon arrangement rule of the sliding-up page; and to set, for the one or more sliding-up pages corresponding to the respective category, one or more sequence numbers respectively.

The sliding-up processing unit is configured to receive the page sliding-up operation instruction from the user and to send a notice to the page sliding-up displaying unit.

In embodiments of the present disclosure, acquiring a page sliding-up operation instruction includes acquiring a single-sliding operation input by the user to the touch screen, and judging whether the single-sliding operation matches with a preset page sliding-up operation; if yes, outputting the page sliding-up operating instruction; and if no, performing a process according to a common single-sliding operation.

In embodiments of the present disclosure, the preset page sliding-up operation includes: within a bottom-left corner region, a bottom-right corner region, a top-left corner region and a top-right corner region, a sliding operation from top-right to bottom-left, or a sliding operation from bottom-left to top-right. An inclination angle from top-right to bottom-left or an inclination angle from bottom-left to top-right is within a preset inclination range.

The page sliding-up displaying unit is configured to receive the notice, and to display the preset sliding-up page having the first sequence number. The displayed sliding-up page is the portion of the touch screen formed by dividing the touch screen and is within the range coverable by the single-sliding operation of the user, the sliding-up page has a plurality of application icons set in advance

As another alternative embodiment, the page sliding-up processing module 401 may further include: a page sliding-up control setting unit.

The page sliding-up control setting unit is configured to set a page sliding-up control of each category at bottom of each sliding-up page.

In embodiments of the present disclosure, as an alternative embodiment, the icon editing module 403 includes: a receiving unit, a marking unit, an application icon displaying unit, an editing unit and an arranging unit (not shown).

The receiving unit is configured to receive an editing operation instruction input by the user to the sliding-up page.

The marking unit is configured to mark each application icon included in the sliding-up page as a cancellable state according to the editing operation instruction received by the receiving unit.

The application icon displaying unit is configured to display, moveably and slidably, application icons corresponding to all applications installed on a mobile terminal device in a page corresponding to an another portion of the touch screen formed by dividing the touch screen.

The editing unit is configured to delete by touching the application icon in the cancellable state, and/or, select an application icon included in the page corresponding to the another portion and to add the application icon selected to an empty location of the sliding-up page.

The arranging unit is configured to move the one or more application icons included in the sliding-up page to sequence.

In embodiments of the present disclosure, as an alternative embodiment, moving the one or more application icons included in the sliding-up page to sequence includes:

for each application corresponding to a respective application icon included in the sliding-up page, when the application is running, acquiring an actual physical memory usage value of the application, and in the sliding-up page, sequencing the application icons corresponding to the applications in an increasing sequence or in a decreasing sequence according to the actual physical memory usage values.

As an alternative embodiment, moving the one or more application icons included in the sliding-up page to sequence includes:

acquiring a usage number of each application corresponding to a respective application icon included in the sliding-up page, within a preset time period;

recording a running duration of each application within the preset time period;

calculating, for each application, a weighted sum of the usage number and the running duration; and

in the sliding-up page, sequencing the application icons corresponding to the applications according to the weighted sums.

As another alternative embodiment, the device may further include a message displaying module 404.

The message displaying module 404 is configured to display one or more messages received by one or more applications on a page corresponding to another portion of the touch screen formed by dividing the touch screen.

In embodiments of the present disclosure, as an alternative embodiment, displaying one or more messages received by one or more applications includes:

displaying, in sequence, the one or more messages received according to a chronological order of receiving the one or more messages; and if a capacity of messages displayed exceeds a capacity of the page corresponding to the another portion, displaying the messages received in an abbreviated form.

In embodiments of the present disclosure, preferably, the device may further include: a restoring module (not shown).

The restoring module is configured to, if the user touches the message displayed, launch an application corresponding to the touched message in the touch screen, and after existing the application, restore the touch screen as the sliding-up page and the page corresponding to the another portion and to delete the touched message from the page corresponding to the another portion.

As another alternative embodiment, displaying one or more messages received by one or more applications includes:

within a preset display time period, buffering one or more offline messages received, when the preset display time period is over,

if the one or more offline messages correspond to one application, when the number of the one or more offline messages is less than a preset first number, displaying the one or more offline messages according to a chronological order of receiving the one or more offline messages; or when the number of the one or more offline messages is not less than the preset first number, displaying offline messages of the preset first number according to the chronological order of receiving the one or more offline messages and displaying the number of the one or more offline messages behind the final offline message displayed; and

if the one or more offline messages correspond to a plurality of applications, setting a message item for each application, in which the message item includes an application icon and the number of offline messages, when the number of the message items exceeds a preset second number, displaying messages items of the preset second number according to a preset displaying strategy and displaying the number of the message items behind the final message items displayed.

As yet another alternative embodiment, the device may further include a page switching module 405.

The page switching module 405 is configured to, in the sliding-up page, receive a page sliding-up switching operation instruction so as to switch the sliding-up page having the first sequence number to a sliding-up page of a next sequence number.

In embodiments of the present disclosure, as an alternative embodiment, a page sliding-up switching operation instruction, so as to switch the sliding-up page having the first sequence number to a sliding-up page of a next sequence number includes:

receiving a horizontal sliding operation input by the user within a preset region in the sliding-up page to output the page sliding-up switching operation instruction; and

switching the sliding-up page having the first sequence number to the sliding-up page of the next sequence number.

As another alternative embodiment, receiving a page sliding-up switching operation instruction, so as to switch the sliding-up page having the first sequence number to a sliding-up page of a next sequence number includes:

receiving a touch input by the user on a preset page switching control included in the sliding-up page to output the page sliding-up switching operation instruction; and

switching the sliding-up page having the first sequence number to the sliding-up page of the next sequence number.

Embodiments of the present disclosure further provide an electronic device. The electronic device includes the device according to any one of embodiments described above.

FIG. 5 is a schematic diagram illustrating an electronic device according to embodiments of the present disclosure, which may realize procedures of embodiments illustrated in FIGS. 1 to 4. As illustrated in FIG. 5, the electronic device may include: a housing 51, a processor 52, a memory 53, a circuit board 54 and a power supply circuit 55. The circuit board 54 is enclosed by the housing 51. The processor 52 and the memory 53 are positioned on the circuit board 54. The power supply circuit 55 is configured to provide power for respective circuits or components of the electronic device. The memory 53 is configured to store executable program codes. The processor 52 is configured to run a program corresponding to the executable program codes by reading the executable program codes stored in the memory 53, to perform following operations:

acquiring a page sliding-up operation instruction from a user to display a preset sliding-up page having a first sequence number and having one or more application icons, in which the sliding-up page is a portion of a touch screen formed by dividing the touch screen and is within a range coverable by a single-sliding operation of the user; and

determining an application icon corresponding to an application launching operation and launching an application corresponding to the application icon, according to the application launching operation from the user to the sliding-up page.

Detail processes of the above steps executed by the processor 52 and detail processes of running program codes to execute further acts by the processor 52 may be referred to above descriptions of embodiments illustrated in FIGS. 1 to 4, which are not elaborated herein.

The electronic device may have various forms, including but not limited to:

(1) A mobile communication device: this typed device has a capacity of mobile communicating, and has a main function of providing voice, data communication. This typed device includes a smart phone (such as an iPhone), a multi-media phone, a functional phone and a low-level phone.

(2) A super-mobile personal computer device: this typed device pertains to a personal computer having a capacity of computing and processing and generally having a capacity of accessing mobile Internet. This typed device includes: PDA (Personal Digital Assistant), MID (Mobile Internet Device) and UMPC (Ultra-mobile Personal Computer) devices, such as an iPad.

(3) Portable entertainment equipment: this typed device may display or play multi-medium content. This typed device includes: an audio, video player (such as iPod), a handheld game player, an E-book, intelligent playthings, and portable vehicle navigation equipment.

(4) A server: a device for providing a calculation service. The server may include a processor, a hard disk, a memory, system buses and the like. The structure of the server is similar to that of computer. As it needs to provide a highly reliable service, there is a high requirement to a processing capability, stability, reliance, security, scalability, manageability.

(5) Other electronic device having a capacity of data interaction.

Furthermore, embodiments of the present disclosure provide a computer readable storage medium. The storage medium is configured to store applications. When the application is executed, a method for launching an application provided in embodiments of the present disclosure is executed. The method for launching an application provided in embodiments of the present disclosure may include the followings:

acquiring a page sliding-up operation instruction from a user to display a preset sliding-up page having a first sequence number and having one or more application icons, in which the sliding-up page is a portion of a touch screen formed by dividing the touch screen and is within a range coverable by a single-sliding operation of the user; and

determining an application icon corresponding to an application launching operation and launching an application corresponding to the application icon, according to the application launching operation from the user to the sliding-up page.

In addition, embodiments of the present disclosure provide an application. When the application is executed, a method for launching an application provided in embodiments of the present is executed. The method for launching an application provided in embodiments of the present includes followings:

acquiring a page sliding-up operation instruction from a user to display a preset sliding-up page having a first sequence number and having one or more application icons, in which the sliding-up page is a portion of a touch screen formed by dividing the touch screen and is within a range coverable by a single-sliding operation of the user; and

determining an application icon corresponding to an application launching operation and launching an application corresponding to the application icon, according to the application launching operation from the user to the sliding-up page.

It would be understood by those skilled in the art that all or a part of the steps carried by the method in the above-described embodiments may be completed by relevant hardware instructed by a program. The program may be stored in a computer readable storage medium. When the program is executed, the procedures in the above-described embodiments may be completed. The above-mentioned storage medium may be a magnetic disc, an optical disc, a read-only memory (ROM), a random access memory (RAM) etc.

Descriptions above are merely specific implementations of the present disclosure. However, the scope of the present disclosure is not limited to the embodiments. Changes and alternatives made to the embodiments by those skilled in the art within the scope of the present disclosure, should be covered by the scope of the present disclosure. Therefore, the scope of the present disclosure should be according to the scope of the appended claims

1. A method for launching an application, comprising:
acquiring a page sliding-up operation instruction from a user to display a preset sliding-up page having a first sequence number and having one or more application icons, wherein the sliding-up page is a portion of a touch screen formed by dividing the touch screen and is within a range coverable by a single-sliding operation of the user; and
determining an application icon corresponding to an application launching operation and launching an application corresponding to the application icon, according to the application launching operation from the user to the sliding-up page.

2. The method according to claim 1, further comprising:
in the sliding-up page, receiving an editing operation instruction from the user and editing the one or more application icons comprised in the sliding-up page.

3. The method according to claim 1, wherein the sliding-up page is set by:
categorizing all application icons on the touch screen according to a preset categorization strategy;
arranging one or more application icons of a respective category into one or more sliding-up pages according to an application icon arrangement rule of the sliding-up page; and
setting, for the one or more sliding-up pages corresponding to the respective category, one or more sequence numbers respectively.

4. The method according claim 3, further comprising:
setting a page sliding-up control of each category at bottom of each sliding-up page.

5. The method according to claim 1, wherein acquiring a page sliding-up operation instruction from a user comprises:
acquiring a single-sliding operation input by the user to the touch screen, and judging whether the single-sliding operation matches with a preset page sliding-up operation; if yes, outputting the page sliding-up operating instruction; and if no, performing a process according to a common single-sliding operation.

6. The method according to claim 5, wherein the preset page sliding-up operation comprises: within a bottom-left corner region, a bottom-right corner region, a top-left corner region and a top-right corner region, a sliding operation from top-right to bottom-left, or a sliding operation from bottom-left to top-right, wherein an inclination angle from top-right to bottom-left or an inclination angle from bottom-left to top-right is within a preset inclination range.

7. The method according to claim 2, wherein editing the one or more application icons comprised in the sliding-up page comprises:
marking each application icon comprised in the sliding-up page as a cancellable state;
in a page corresponding to an another portion of the touch screen formed by dividing the touch screen, displaying, moveably and slidably, application icons corresponding to all applications installed on a mobile terminal device;
deleting by touching the application icon in the cancellable state, and/or, selecting an application icon comprised in the page corresponding to the another portion and adding the application icon selected to an empty location of the sliding-up page; and
moving the one or more application icons comprised in the sliding-up page to sequence.

8. The method according to claim 7, wherein moving the one or more application icons comprised in the sliding-up page to sequence comprises:
for each application corresponding to a respective application icon comprised in the sliding-up page, when the application is running, acquiring an actual physical memory usage value of the application, and in the sliding-up page, sequencing the application icons corresponding to the applications in an increasing sequence or in a decreasing sequence according to the actual physical memory usage values.

9. The method according to claim 7, wherein moving the one or more application icons comprised in the sliding-up page to sequence comprises:
acquiring a usage number of each application corresponding to a respective application icon comprised in the sliding-up page, within a preset time period;
recording a running duration of each application within the preset time period;
calculating, for each application, a weighted sum of the usage number and the running duration; and
in the sliding-up page, sequencing the application icons corresponding to the applications according to the weighted sums.

10. The method according to claim 1, further comprising:
displaying one or more messages received by one or more applications on a page corresponding to another portion of the touch screen formed by dividing the touch screen.

11. The method according to claim 10, wherein displaying one or more messages received by one or more applications comprises:
displaying, in sequence, the one or more messages received according to a chronological order of receiving the one or more messages; and if a capacity of messages displayed exceeds a capacity of the page corresponding to the another portion, displaying the messages received in an abbreviated form.

12. The method according to claim 11, further comprising:
if the user touches the message displayed, launching an application corresponding to the touched message in the touch screen, and after existing the launched application, restoring the touch screen as the sliding-up page and the page corresponding to the another portion and deleting the touched message from the page corresponding to the another portion.

13. The method according to claim 10, wherein displaying one or more messages received by one or more applications comprises:
within a preset display time period, buffering one or more offline messages received, when the preset display time period is over,
if the one or more offline messages correspond to one application, when the number of the one or more offline messages is less than a preset first number, displaying the one or more offline messages according to a chronological order of receiving the one or more offline messages; or when the number of the one or more offline messages is not less than the preset first number, displaying offline messages of the preset first number according to the chronological order of receiving the one or more offline messages and displaying the number of the one or more offline messages behind the final offline message displayed; and
if the one or more offline messages correspond to a plurality of applications, setting a message item for each application, wherein the message item comprises an application icon and the number of offline messages, when the number of the message items exceeds a preset second number, displaying messages items of the preset second number according to a preset displaying strategy and displaying the number of the message items behind the final message items displayed.

14. The method according to claim 1, further comprising:
in the sliding-up page, receiving a page sliding-up switching operation instruction, so as to switch the sliding-up page having the first sequence number to a sliding-up page having a next sequence number.

15. The method according to claim 14, wherein receiving a page sliding-up switching operation instruction, so as to switch the sliding-up page having the first sequence number to a sliding-up page of a next sequence number comprises:
receiving a horizontal sliding operation input by the user within a preset region in the sliding-up page to output the page sliding-up switching operation instruction; and
switching the sliding-up page having the first sequence number to the sliding-up page of the next sequence number.

16. The method according to claim 14, wherein receiving a page sliding-up switching operation instruction, so as to switch the sliding-up page having the first sequence number to a sliding-up page of a next sequence number comprises:
receiving a touch input by the user on a preset page switching control comprised in the sliding-up page to output the page sliding-up switching operation instruction; and
switching the sliding-up page having the first sequence number to the sliding-up page of the next sequence number.

17-32. (canceled)

33. An electronic device, comprising: a housing, a processor, a memory, a circuit board and a power supply circuit, wherein the circuit board is enclosed by the housing; the processor and the memory are positioned on the circuit board; the power supply circuit is configured to provide power for respective circuits or components of the electronic device; the memory is configured to store executable program codes; and the processor is configured to run a program corresponding to the executable program codes by reading the executable program codes stored in the memory, to perform following operations:
acquiring a page sliding-up operation instruction from a user to display a preset sliding-up page having a first sequence number and having one or more application icons, wherein the sliding-up page is a portion of a touch screen formed by dividing the touch screen and is within a range coverable by a single-sliding operation of the user; and
determining an application icon corresponding to an application launching operation and launching an application corresponding to the application icon, according to the application launching operation from the user to the sliding-up page.

34. A non-transitory computer readable storage medium, with instructions stored, wherein when the instructions are executed by a processor of a terminal, the terminal execute a method for launching an application, the method comprising:
acquiring a page sliding-up operation instruction from a user to display a preset sliding-up page having a first sequence number and having one or more application icons, wherein the sliding-up page is a portion of a touch screen formed by dividing the touch screen and is within a range coverable by a single-sliding operation of the user; and
determining an application icon corresponding to an application launching operation and launching an application corresponding to the application icon, according to the application launching operation from the user to the sliding-up page.

35. (canceled)

36. The electronic device according to claim 33, wherein the processor is configured to perform following operations:
in the sliding-up page, receiving an editing operation instruction from the user and editing the one or more application icons comprised in the sliding-up page.

37. The electronic device according to claim 33, wherein the processor is configured to perform following operations:
in the sliding-up page, receiving a page sliding-up switching operation instruction, so as to switch the sliding-up page having the first sequence number to a sliding-up page having a next sequence number.
